(19) United States
(12) Patent Application Publication
(10) Pub. No.: US 2026/0339275 A1
(43) Pub. Date: Oct. 29, 2026

(54) PARAMETER ADJUSTING DEVICE, PARAMETER ADJUSTING METHOD, AND PROGRAM

(71) Applicant: Panasonic Intellectual Property Management Co., Ltd., Osaka (JP)

(72) Inventors: Naganori SHIRAKATA, Osaka (JP); Shun TAKAYANAGI, Osaka (JP); Taichi SHIMIZU, Osaka (JP); Mei OKAMOTO, Kanagawa (JP); Taichi SATO, Kyoto (JP)

(21) Appl. No.: 19/116,136

(22) PCT Filed: Nov. 29, 2023
(86) PCT No.: PCT/JP2023/042817

§ 371 Date: Mar. 27, 2025

(30) Foreign Application Priority Data
Jan. 18, 2023 (JP) 2023-005785

(51) Int. Cl. G05B 13/02

(52) U.S. Cl. CPC G05B 13/024

(57) ABSTRACT

A parameter adjusting device according to an exemplary embodiment of the present disclosure comprises: a generating circuit for acquiring past parameter values for each of a plurality of control parameters set in the past for a piece of equipment, and generating, on the basis of the past parameter values, at least one of first information indicating a parameter value dispersion state for each control parameter and second information indicating a state for each setting, obtained by expressing the past parameter value using at least one line segment; and a display control circuit for displaying a current parameter value set for each of the plurality of control parameters on a user interface, superimposed on the at least one of the first information and the second information.

### TECHNICAL FIELD

The present disclosure relates to a parameter adjustment apparatus, a parameter adjustment method, and a program.

### BACKGROUND ART

In production equipment used in factories, such as component mounting machines and assembly robots, a plurality of servo control motors are combined to perform complex and precise operation control. In such an apparatus, an operation of a control target is controlled according to numerous control parameters. To achieve the desired performance, users empirically adjust the control parameters.

An adjustment process of such control parameters becomes more difficult as the operating conditions become diverse and complex, and the number of parameters increases, requiring significant effort and time. Therefore, there is an increasing demand to automate these adjustment processes.

For this reason, technology has been disclosed for modeling equipment to be controlled and extracting candidate parameters for adjustment using simulation (see, for example, Patent Literature (hereinafter, referred to as “PTL”) 1).

### CITATION LIST

### Patent Literature

### PTL 1

Japanese Patent Application Laid-Open No. 2017-167607

### SUMMARY OF INVENTION

However, when the number of control parameters reaches tens to hundreds, and the number of operating conditions that meet the performance requirements also becomes numerous, such as tens, the number of combinations becomes enormous, making it difficult to efficiently configure appropriate exploration priorities, exploration ranges, etc. As a result, it may become difficult to efficiently configure appropriate parameter values.

A non-limiting and exemplary embodiment of the present disclosure facilitates providing a parameter adjustment apparatus, a parameter adjustment method, and a program that enable efficient configuration of parameter values.

A parameter adjustment apparatus according to one exemplary embodiment of the present disclosure includes: generation circuitry, which, in operation, acquires a past parameter value for each of a plurality of control parameters configured for equipment in a past, and generates at least one of first information and second information based on the past parameter value, the first information indicating a parameter value scatter state for each control parameter, the second information indicating a state for each configuration, where the past parameter value is expressed using one or more line segments; and display control circuitry, which, in operation, displays a current parameter value configured for each of the plurality of control parameters on a user interface such that the current parameter value is superimposed on at least one of the first information and the second information.

A parameter adjustment method according to one exemplary embodiment of the present disclosure is performed by a parameter adjustment apparatus and includes: acquiring a past parameter value for each of a plurality of control parameters configured for equipment in a past; generating at least one of first information and second information based on the past parameter value, the first information indicating a parameter value scatter state for each control parameter, the second information indicating a state for each configuration, where the past parameter value is expressed using one or more line segments; and displaying a current parameter value configured for each of the plurality of control parameters on a user interface such that the current parameter value is superimposed on at least one of the first information and the second information.

A program according to one exemplary embodiment of the present disclosure is a program for causing a computer to execute: acquiring a past parameter value for each of a plurality of control parameters configured for equipment in a past; generating at least one of first information and second information based on the past parameter value, the first information indicating a parameter value scatter state for each control parameter, the second information indicating a state for each configuration, where the past parameter value is expressed using one or more line segments; and displaying a current parameter value configured for each of the plurality of control parameters on a user interface such that the current parameter value is superimposed on at least one of the first information and the second information.

It should be noted that these general or specific embodiments may be implemented as a system, an apparatus, a method, an integrated circuit, a computer program, or a storage medium, or any combination thereof.

According to one exemplary embodiment of the present disclosure, it is possible to provide technology that enables efficient configuration of parameter values.

Additional benefits and effects of one exemplary embodiment of the present disclosure will become apparent from the specification and drawings. Such benefits and/or effects are provided by various embodiments and features described in the specification and drawings, but not all need to be provided to obtain one or more of the same features.

### BRIEF DESCRIPTION OF DRAWINGS

FIG. 1 is a block diagram illustrating an example of a parameter automatic adjustment system according to an embodiment of the present disclosure;

FIG. 2A is a block diagram illustrating an example of a hardware configuration of the parameter automatic adjustment apparatus according to an embodiment of the present disclosure;

FIG. 2B is a block diagram illustrating an example of a functional configuration of the parameter automatic adjustment apparatus according to an embodiment of the present disclosure;

FIG. 2C is a block diagram illustrating a more detailed example of the functional configuration of the parameter automatic adjustment system according to an embodiment of the present disclosure;

FIG. 3A illustrates an example of a data configuration of adjustment items according to an embodiment of the present disclosure;

FIG. 3B illustrates an example of a data configuration of adjustment items according to an embodiment of the present disclosure;

FIG. 3C illustrates an example of a data configuration of adjustment items according to an embodiment of the present disclosure;

FIG. 4 illustrates an example of a display screen (UI screen) displayed on a UI section according to an embodiment of the present disclosure;

FIG. 5 illustrates an example of the display screen (UI screen) displayed on the UI section according to an embodiment of the present disclosure;

FIG. 6 is a flowchart illustrating an exemplary operation of the parameter automatic adjustment system according to an embodiment of the present disclosure;

FIG. 7 is a flowchart showing details of step S608 shown in FIG. 6;

FIG. 8 illustrates an example of a display screen (UI screen) related to step S707 shown in FIG. 7;

FIG. 9 illustrates an example of a display screen (UI screen) related to step S712 shown in FIG. 7; and

FIG. 10 is a block diagram illustrating an example of a remote parameter automatic adjustment system according to a variation of the embodiment of the present disclosure.

### DESCRIPTION OF EMBODIMENTS

Hereinafter, embodiments of the present disclosure will be described in detail with reference to the drawings as appropriate. However, unnecessarily detailed descriptions may be omitted. For example, detailed descriptions of well-known matters and redundant descriptions of substantially the same configuration may be omitted. This is to avoid unnecessary redundancy of the following description and to facilitate understanding by a person skilled in the art.

Note that the accompanying drawings and the following description are provided so that a person skilled in the art understands the present disclosure sufficiently, and are not intended to limit the subject matters recited in the claims.

### Embodiment

### <Outline Configuration of Parameter Automatic Adjustment System>

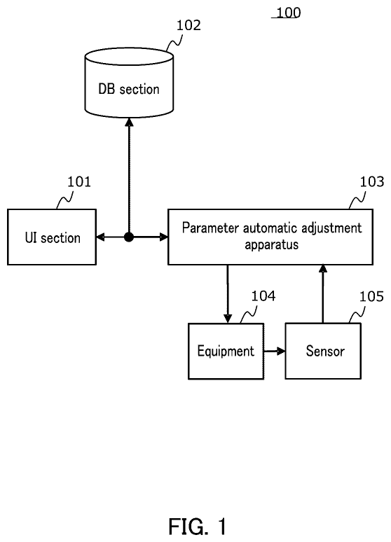

FIG. 1 is a block diagram illustrating an example of a parameter automatic adjustment system according to an embodiment of the present disclosure. As shown in FIG. 1, parameter automatic adjustment system 100 includes user interface (UI) section 101, database (DB) section 102, parameter automatic adjustment apparatus 103, equipment 104, and sensor 105. Parameter automatic adjustment apparatus 103 is an example of a parameter adjustment apparatus and a computer according to the present disclosure. UI section 101 is an example of a display according to the present disclosure.

Parameter automatic adjustment system 100 explores and adjusts control parameters so that a predetermined operation (operating condition) to be performed by equipment 104, such as a component mounting machine, satisfies an objective value representing predetermined performance.

In the present specification, parameters representing operating conditions (e.g., movement speed, movement distance, stop position, etc.) are referred to as operation parameters (or operating condition parameters), and parameters inside equipment 104 that realize the operating conditions (e.g., control gain, filter time constant, etc.) are referred to as control parameters (or control condition parameters). The target of parameter exploration is the control parameters. Here, exploration means automatically finding parameter values that satisfy an objective value using various known algorithms. Adjustment means varying parameter values through exploration or manually. Parameters related to the exploration (exploration priority, exploration range, number of times of exploration, exploration conditions (objective value configuration), etc.) are called hyperparameters.

UI section 101 is implemented by a UI device or UI apparatus such as a display, keyboard, mouse, etc., and receives adjustment items (e.g., operating conditions, desired performance, priority parameters, exploration range, etc.) from a user (by user operating UI section 101) and passes (outputs, transmits) the received adjustment items to parameter automatic adjustment apparatus 103 (more specifically, adjustment item setter 106 described later) for parameter automatic adjustment apparatus 103 to configure the adjustment items. Receiving by UI section 101 the adjustment items from the user and passing them to parameter automatic adjustment apparatus 103 may mean that the user configures the adjustment items.

UI section 101 displays information configured in parameter automatic adjustment apparatus 103, trial history, etc., output (or transmitted) from parameter automatic adjustment apparatus 103, in text and/or graphically. Here, trial refers to a series of operations in which parameter automatic adjustment apparatus 103 evaluates control parameter values that are candidates for configuration, and based on the evaluation results, determines the next candidate control parameter values to be configured for equipment 104, thereby optimizing the control parameter values configured for equipment 104.

UI section 101 is illustrated separately from parameter automatic adjustment apparatus 103, but it may be integrated into parameter automatic adjustment apparatus 103.

DB section 102 is realized by a storage device or apparatus such as a hard disk drive in a data management server or data center, and stores profiles, histories of parameters configured in the past, and the like of equipment 104 to be adjusted (also referred to as an optimization target) and/or sensor 105 used for operational evaluation, as will be described in more detail below.

Additionally, the profiles, histories of parameters configured in the past, and the like of equipment 104 to be adjusted and/or sensors 105 used for operational evaluation stored in DB section 102 are read by parameter automatic adjustment apparatus 103 (more specifically, adjustment item setter 106, which will be described later).

DB section 102 is illustrated as separate from parameter automatic adjustment apparatus 103, but it may be integrated into parameter automatic adjustment apparatus 103.

Parameter automatic adjustment apparatus 103 performs the exploration and adjustment of the control parameters for equipment 104 by determining the exploration range of the control parameters for equipment 104 based on the adjustment items received from the user and information stored in DB section 102. For example, parameter automatic adjustment apparatus 103 performs the exploration and adjustment of the control parameters as follows.

Parameter automatic adjustment apparatus 103 generates a combination of control parameter values (hereinafter referred to as a vector) that improves the objective value based on a past trial result.

Parameter automatic adjustment apparatus 103 configures a trial vector, consisting of a generated vector and operating conditions (operating parameters) used for adjustment, in parameter automatic adjustment apparatus 103 and passes it to equipment 104 (outputs, transmits, or configures it). This allows parameter automatic adjustment apparatus 103 to control equipment 104 to operate according to the trial vector.

It should be noted that when an apparatus or functional unit (processor) configures information such as parameters, it may mean one or more of the following: the apparatus or functional unit (processor) stores such information in a data table, operates according to such information, and controls other apparatuses or functional units (processors) to operate according to such information.

Parameter automatic adjustment apparatus 103 receives an operation result of equipment 104, which operated according to the trial vector, from sensor 105, and evaluates the operation result to determine whether the objective value has improved. Parameter automatic adjustment apparatus 103 uses this series of trial results as a prior distribution for the next vector generation.

Parameter automatic adjustment apparatus 103 stores (writes) a trial value (parameter value) distribution for each parameter, a vector distribution for each trial (or configuration), and an evaluation value distribution for each trial (or configuration) in DB section 102.

Parameter automatic adjustment apparatus 103 generates a parameter value scatter plot (first information) based on the trial value distribution for each parameter, a vector plot (line graph, second information) based on the vector distribution for each trial, and a distribution diagram (histogram) of evaluation values (evaluation scores according to the present disclosure) based on the evaluation value distribution for each trial, and passes these to UI section 101 (outputs, transmits) for display by UI section 101.

Equipment 104 may be, for example, an implementation machine such as production equipment (subject to control parameter adjustment), or a model simulating the operation of the implementation machine. When equipment 104 is a model, the model may be realized by hardware, software, or a combination of hardware and software. The model may be referred to as virtual equipment.

Equipment 104 executes predetermined operations according to the trial vector configured by parameter automatic adjustment apparatus 103.

Sensor 105 may be an actual apparatus or a model simulating the operation of the sensor. When sensor 105 is a model, the model may be realized by hardware, software, or a combination of hardware and software. The sensor may be referred to as a virtual sensor.

Sensor 105 detects (senses, measures) the operation result (e.g., performance values) of equipment 104 operating according to the configured trial vector, and passes (outputs, transmits) the detected operation result to parameter automatic adjustment apparatus 103 (more specifically, operation evaluator 109, which will be described later).

The performance values related to operation may include, for example, physical quantities such as displacement, speed, vibration, noise, voltage, and current at an adjustment target location.

In this way, parameter automatic adjustment system 100 allows information, trial history, and the like configured for parameter automatic adjustment apparatus 103 to be displayed to the user, enabling the user to manipulate exploration conditions while referring to (e.g., comparing) parameters configured in the past, thereby making it possible to efficiently configure appropriate control parameters. Additionally, it becomes possible to efficiently perform the exploration and adjustment of the control parameters. Furthermore, the user can easily grasp the progress of the exploration or adjustment through the displayed information, trial history, etc. This enables even inexperienced users, such as newcomers, to efficiently configure appropriate control parameters.

Note that one or more of the blocks illustrated in the figures may be implemented within a single apparatus or may be implemented in different apparatuses. For example, equipment 104 may be implemented as single apparatus including UI section 101, DB section 102, parameter automatic adjustment apparatus 103, and sensor 105. Alternatively, parameter automatic adjustment apparatus 103 may be realized on the cloud, and UI section 101 may be implemented on a user's local Personal Computer (PC), smartphone, tablet, etc., with each block connected via a communication network (not illustrated). Additionally, a plurality of instances of equipment 104 and/or sensor 105 may be installed.

Furthermore, UI section 101 and/or parameter automatic adjustment apparatus 103 may not only configure adjustment items input by the user but also perform configuration of control parameters and acquisition of operation results by operating a Graphical User Interface (GUI) of adjustment software of existing technology for manually adjusting parameters of equipment 104 of existing technology using Robotic Process Automation (RPA) that automatically controls using image recognition, etc. This allows parameter automatic adjustment to be performed even for equipment 104 of existing technology that does not have a dedicated communication interface.

### <Configuration of Parameter Automatic Adjustment Apparatus>

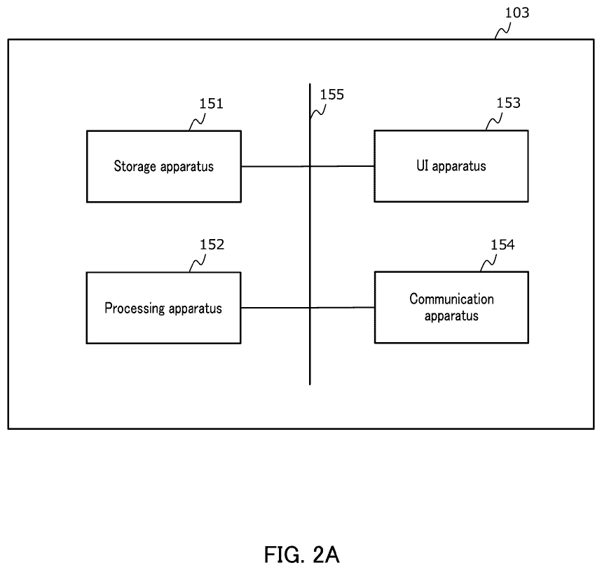

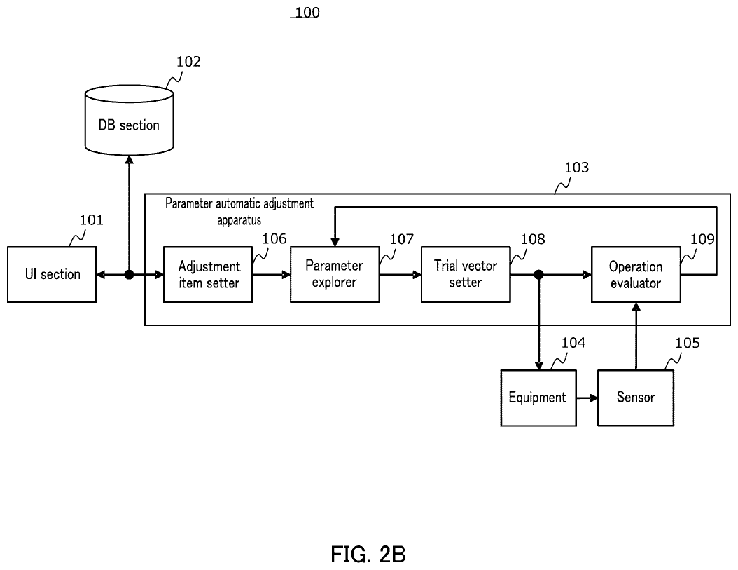

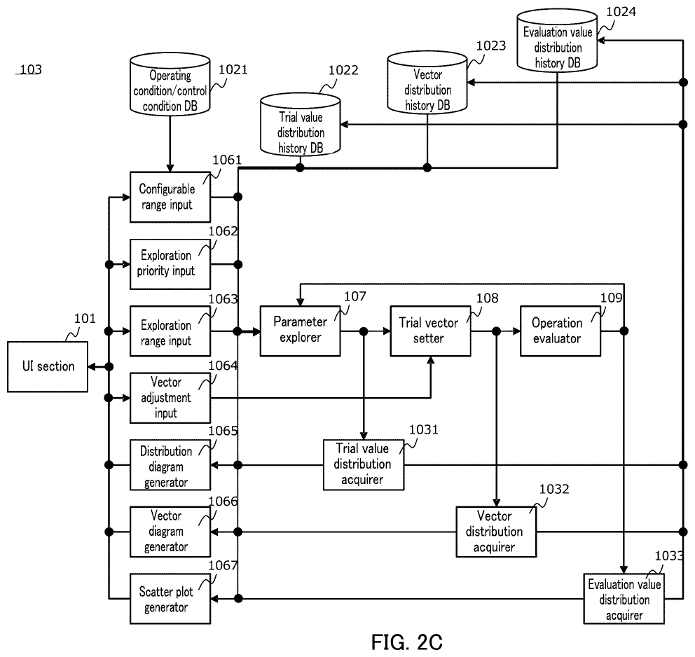

Parameter automatic adjustment apparatus 103 is realized by any computing apparatus (calculator, computer) such as a server, PC, or the like, or an information processing apparatus. For example, parameter automatic adjustment apparatus 103 may have the hardware configuration shown in FIG. 2A. FIG. 2A is a block diagram illustrating an example of the hardware configuration of the parameter automatic adjustment apparatus according to an embodiment of the present disclosure. For example, as shown in FIG. 2A, parameter automatic adjustment apparatus 103 may include storage apparatus 151, processing apparatus 152, UI apparatus 153, and communication apparatus 154, each interconnected via bus 155.

Programs or instructions for realizing functions and processes described later in parameter automatic adjustment apparatus 103 may be downloaded from some external apparatus (e.g., server) via a network or the like, or may be provided from a removable storage medium such as a Compact Disc Read Only Memory (CD-ROM) or flash memory.

Storage apparatus 151 is realized by a Random Access Memory (RAM), flash memory, hard disk drive, and the like and stores files, data, and the like used for executing installed programs or instructions, along with the programs or instructions. Storage apparatus 151 may include a non-transitory storage medium.

When DB section 102 is integrated into parameter automatic adjustment apparatus 103, DB section 102 may be stored in storage apparatus 151.

Processing apparatus 152 may be realized by a general-purpose processor or controller (circuit) or by a dedicated processor or controller (circuit). When realized by a general-purpose processor, processing apparatus 152 may be implemented by one or more Central Processing Units (CPUs), Graphics Processing Units (GPUs), processing circuitry, and the like which may be composed of one or more processor cores, and executes the functions and processes of parameter automatic adjustment apparatus 103 described above and later, in accordance with data such as programs or instructions stored in storage apparatus 151, parameters used to execute the programs or instructions, etc.

UI apparatus 153 may include an input apparatus such as a keyboard, mouse, camera, and microphone; an output apparatus such as a display, speaker, headset, and printer; and an input/output apparatus such as a touch panel, and realizes an interface between the user and parameter automatic adjustment apparatus 103. For example, user operates parameter automatic adjustment apparatus 103 by using the keyboard, mouse, and the like to operate a GUI displayed on the display or touch panel.

When UI section 101 is incorporated into parameter automatic adjustment apparatus 103, UI section 101 may be realized by part or all of UI apparatus 153.

Communication apparatus 154 may be realized by various communication circuits that execute communication processing with a communication network such as an external apparatus, the Internet, a Local Area Network (LAN), and a Virtual Private Network (VPN).

The hardware configuration of parameter automatic adjustment apparatus 103 described above is merely an example, and parameter automatic adjustment apparatus 103 according to the present disclosure may be realized by other suitable hardware configurations.

FIG. 2B is a block diagram illustrating an example of the functional configuration of the parameter automatic adjustment apparatus according to an embodiment of the present disclosure. For example, as shown in FIG. 2B, parameter automatic adjustment apparatus 103 includes adjustment item setter 106, parameter explorer 107, trial vector setter 108, and operation evaluator 109. Also, as will be described later with reference to FIG. 2C, parameter automatic adjustment apparatus 103 includes other components, and adjustment item setter 106 includes various sub-functional section or processors. Adjustment item setter 106 is an example of a generator and display controller according to the present disclosure. Parameter explorer 107 is an example of a parameter value generator according to the present disclosure. Operation evaluator 109 is an example of an evaluator according to the present disclosure.

Adjustment item setter 106, based on information (such as configuration items) input from UI section 101 and/or DB section 102, passes (outputs, transmits, configures) the operating conditions (operation parameters) used for parameter adjustment, control parameters to be adjusted, and hyperparameters for configuring the exploration to parameter explorer 107.

Adjustment item setter 106 generates a trial value distribution diagram, a vector diagram, an evaluation value distribution diagram, and the like based on information from trial value distribution acquirer 1031, vector distribution acquirer 1032, evaluation value distribution acquirer 1033, trial value distribution history DB 1022, vector distribution history DB 1023, evaluation value distribution history DB 1024, and the like as will be described later.

Adjustment item setter 106 outputs (or transmits) the generated trial value distribution diagram, vector diagram, evaluation value distribution diagram, and the like to UI section 101, thereby displaying the generated trial value distribution diagram, vector diagram, evaluation value distribution diagram, and the like on UI section 101.

Parameter explorer 107 performs an exploration of control parameters based on the configuration by adjustment item setter 106. Various known algorithms can be used for the parameter exploration by parameter explorer 107. For example, heuristic algorithms such as Bayesian optimization, genetic algorithms, and particle swarm optimization; mathematical programming methods; various solutions in combinatorial optimization; and the like may be used.

Parameter explorer 107 generates a combination (vector) of control parameter values that improve the objective value based on past trial results.

Parameter explorer 107 passes (outputs, transmits, configures) a trial vector, consisting of the generated vector and the operating conditions (operation parameters) used for adjustment, to trial vector setter 108.

Parameter explorer 107 determines whether the objective value input from operation evaluator 109 has improved. Parameter explorer 107 uses the trial result as a prior distribution for the next vector generation. When parameter explorer 107 determines that a vector that achieves (satisfies) the objective value has been found, it decides that vector as the parameter value to be finally configured for equipment 104 and ends the exploration.

Trial vector setter 108 passes (outputs, transmits, configures) the trial vector input from parameter explorer 107 to equipment 104 and operation evaluator 109.

When the trial vector is composed of the generated vector (control parameters) and a plurality of operating conditions (operation parameters), trial vector setter 108 operates equipment 104 under each operating condition.

For example, trial vector setter 108 configures equipment 104 with the control parameters, then configures a single operating condition for single equipment 104, and operates equipment 104 in sequence.

Also, for example, when there are a plurality of pieces of identical equipment 104, trial vector setter 108 may configure the control parameters for all the pieces of identical equipment 104, then configure different operating conditions for each identical equipment 104, and operate the pieces of identical equipment 104 in parallel.

Operation evaluator 109 evaluates the operation result of equipment 104, which operated according to the configured trial vector, based on the performance values input from sensor 105.

When the trial vector is composed of the generated vector (control parameters) and a plurality of operating conditions (operation parameters), operation evaluator 109 evaluates the operation under each operating condition.

Operation evaluator 109 converts the performance values from sensor 105 into evaluation values for the generated vector (control parameters) according to the hyperparameters, converts these multiple evaluation values into an objective value, and feeds back (provides, transmits, outputs) the objective value to parameter explorer 107. Details of the evaluation value and objective value will be described later.

In this way, parameter automatic adjustment system 100 allows the information, trial history, and the like configured for parameter automatic adjustment apparatus 103 to be displayed to the user, enabling the user to manipulate the exploration conditions while referring to (e.g., comparing) configured parameters in the past, thereby making it possible to efficiently configure appropriate control parameters. Moreover, it becomes possible to efficiently perform the exploration and adjustment of control parameters. Additionally, the user can easily grasp the progress during the exploration or adjustment through the displayed information, trial history, etc. As a result, even inexperienced users such as newcomers can efficiently configure appropriate control parameters.

### <Detailed Configuration of Parameter Automatic Adjustment System>

FIG. 2C is a block diagram illustrating a more detailed example of the functional configuration of the parameter automatic adjustment system according to an embodiment of the present disclosure. As shown in FIG. 2C, DB section 102 includes operating condition/control condition DB 1021, trial value distribution history DB 1022, vector distribution history DB 1023, and evaluation value distribution history DB 1024. Also, as shown in FIG. 2C, adjustment item setter 106 includes configurable range input 1061, exploration priority input 1062, exploration range input 1063, vector adjustment input 1064, scatter plot generator 1065, vector diagram generator 1066, and distribution diagram generator 1067. Furthermore, as shown in FIG. 2C, parameter automatic adjustment apparatus 103 further includes trial value distribution acquirer 1031, vector distribution acquirer 1032, and evaluation value distribution acquirer 1033. Scatter plot generator 1065, vector diagram generator 1066, and distribution diagram generator 1067 are examples of the generator and display controller according to the present disclosure.

As described above, parameter automatic adjustment apparatus 103 (adjustment item setter 106) configures the operating conditions (operation parameters) used for parameter adjustment, control parameters to be adjusted, and hyperparameters for configuring the exploration based on information (such as configuration items) input from UI section 101 and/or DB section 102 (DBs 1021 to 1024).

Parameter automatic adjustment apparatus 103 (parameter explorer 107) generates and configures trial vectors based on these parameters.

Parameter automatic adjustment apparatus 103 (operation evaluator 109) performs operation evaluation on equipment 104 as an optimization target based on the trial vector.

Parameter automatic adjustment apparatus 103 (parameter explorer 107) repeats trials to explore parameters that satisfy the objective value based on the operation evaluation results. During this process, parameter automatic adjustment apparatus 103 (trial value distribution acquirer 1031, vector distribution acquirer 1032, and evaluation value distribution acquirer 1033) acquires the distribution of trial values, vectors, and evaluation values, and parameter automatic adjustment apparatus 103 (scatter plot generator 1065, vector diagram generator 1066, and distribution diagram generator 1067) generates trial value scatter diagrams, vector diagrams, and evaluation value distribution diagrams, stores their history in DB section 102 (DBs 1021 to 1024), and UI section 101 displays them. The following explains this.

Operating condition/control condition DB 1021 stores definitions of operation parameters and control parameters that can be configured for equipment 104, which is the target for parameter adjustment (profiles such as parameter types, configurable value ranges, etc.). The information stored in operating condition/control condition DB 1021 is read by configurable range input 1061 (or operating condition/control condition DB 1021 outputs the stored information to configurable range input 1061).

Trial value distribution history DB 1022 stores the information output by trial value distribution acquirer 1031. The information stored in trial value distribution history DB 1022 is read by parameter explorer 107 and scatter plot generator 1065 (or trial value distribution history DB 1022 outputs the stored information to parameter explorer 107 and scatter plot generator 1065).

Vector distribution history DB 1023 stores the information output by vector distribution acquirer 1032. The information stored in vector distribution history DB 1023 is read by parameter explorer 107 and vector diagram generator 1066 (or vector distribution history DB 1023 outputs the stored information to parameter explorer 107 and vector diagram generator 1066).

Evaluation value distribution history DB 1024 stores the information output by evaluation value distribution acquirer 1033. The information stored in evaluation value distribution history DB 1024 is read by parameter explorer 107 and distribution diagram generator 1067 (or evaluation value distribution history DB 1024 outputs the stored information to parameter explorer 107 and distribution diagram generator 1067).

Configurable range input 1061 outputs the operation parameters and control parameters read (or input) from operating condition/control condition DB 1021 to UI section 101, thereby displaying the operation parameters and control parameters on UI section 101. Configurable range input 1061 receives the configurable range of each parameter based on the user's operation on UI section 101 and outputs the received configurable range to parameter explorer 107.

Exploration priority input 1062 receives the priority of parameters to be explored by parameter explorer 107 based on the user's operation on UI section 101 (parameter order rearrangement handle 4011 described later) and outputs the received priority to parameter explorer 107.

Exploration range input 1063 receives the exploration range of parameters to be explored by parameter explorer 107 based on the user's operation on UI section 101 (exploration lower limit handle 4013 and/or exploration upper limit handle 4014 described later) and outputs the received exploration range to parameter explorer 107.

Vector adjustment input 1064 receives an input related to the adjustment of parameter values based on the user's operation on UI section 101 (configuration value handle 4016 described later) and outputs the received input related to the adjustment to trial vector setter 108.

Scatter plot generator 1065 generates a scatter plot of trial values for each parameter based on the information input from trial value distribution acquirer 1031 and the information read (or input) from trial value distribution history DB 1022. Scatter plot generator 1065 outputs the generated scatter plot of trial values for each parameter (e.g., past trial value scatter plot, current trial value scatter plot, etc.) to UI section 101, thereby displaying the scatter plot of trial values for each operation parameter on UI section 101.

For example, for the past trial value scatter plot, scatter plot generator 1065 obtains the respective past parameter values of the plurality of control parameters configured for equipment 104 in the past from trial value distribution history DB 1022 and generates a scatter plot of trial values (parameter values) for each control parameter based on the respective past parameter values of the plurality of control parameters. For the current trial value scatter plot, scatter plot generator 1065 obtains the respective current parameter values configured for the plurality of control parameters of equipment 104 from trial value distribution acquirer 1031 and generates a scatter plot of current trial values (parameter values) based on these current parameter values. Then, scatter plot generator 1065 superimposes the current trial value scatter plot on the past trial value scatter plot.

Vector diagram generator 1066 generates a vector diagram for each trial (or configuration) based on the information input from vector distribution acquirer 1032 and the information read (or input) from vector distribution history DB 1023. Vector diagram generator 1066 outputs the generated vector diagram for each trial (e.g., past configuration vector diagram, current trial vector diagram, optimal vector diagram, etc.) to UI section 101, thereby displaying the vector diagram for each trial on UI section 101.

For example, for the past configuration vector diagram, vector diagram generator 1066 obtains the respective past parameter values of the plurality of control parameters configured for equipment 104 in the past from vector distribution history DB 1023 and generates a line graph for each trial (or configuration) that represents the respective past parameter values of the plurality of control parameters as a polygonal line (one or more line segments) based on the respective past parameter values of the plurality of control parameters. For the current trial vector diagram, vector diagram generator 1066 obtains the respective current parameter values configured for the plurality of control parameters of equipment 104 from vector distribution acquirer 1032 and generates a line graph that represents the respective current parameter values configured for the plurality of control parameters as a polygonal line based on these current parameter values. Then, vector diagram generator 1066 superimposes the current trial vector diagram on the past configuration vector diagram.

Distribution diagram generator 1067 generates an evaluation value distribution diagram for each trial (or configuration) based on the information input from evaluation value distribution acquirer 1033 and the information read (or input) from evaluation value distribution history DB 1024. Distribution diagram generator 1067 outputs the generated evaluation value distribution diagram for each trial (e.g., past vector evaluation value distribution diagram, current trial vector evaluation value distribution diagram, optimal vector evaluation value distribution diagram, etc.) to UI section 101, thereby displaying the evaluation value distribution diagram for each trial on UI section 101. Distribution diagram generator 1067 can include, as necessary, an evaluation value minimum line/maximum line representing the minimum/maximum evaluation value in the selected evaluation value distribution and an objective value line representing the objective value of the parameter exploration in the evaluation value distribution diagram.

For example, for the past vector evaluation value distribution diagram, distribution diagram generator 1067 obtains the past evaluation values for each trial (or configuration) from evaluation value distribution history DB 1024 and generates a histogram representing the distribution of past evaluation scores based on the past evaluation values for each trial. For the current trial vector evaluation value distribution diagram, distribution diagram generator 1067 obtains the evaluation value of the current trial (or configuration) from evaluation value distribution acquirer 1033 and generates a histogram representing the distribution of current evaluation scores based on the evaluation value of the current trial. Then, distribution diagram generator 1067 superimposes the current trial vector evaluation value distribution diagram on the past vector evaluation value distribution diagram.

Trial value distribution acquirer 1031 receives the parameter values tried by parameter explorer 107, determines the trial value distribution for each parameter based on the received parameter values, and outputs the determined trial value distribution for each parameter to scatter plot generator 1065 and trial value distribution history DB 1022 (stores (writes) it in trial value distribution history DB 1022).

Vector distribution acquirer 1032 receives the vector configured by trial vector setter 108, determines the vector distribution for each trial based on the received vector, and outputs the determined vector distribution for each trial to vector diagram generator 1066 and vector distribution history DB 1023 (stores (writes) it in vector distribution history DB 1023).

Evaluation value distribution acquirer 1033 receives the evaluation value evaluated by operation evaluator 109, determines the evaluation value distribution for each trial based on the received evaluation value, and outputs the determined evaluation value distribution for each trial to distribution diagram generator 1067 and evaluation value distribution history DB 1024 (stores (writes) it in evaluation value distribution history DB 1024).

In this way, parameter automatic adjustment system 100 makes it possible to display the information, trial history, and the like configured for parameter automatic adjustment apparatus 103 to the user, allowing the user to manipulate the exploration conditions while referring to (e.g., comparing) parameters configured in the past, thereby enabling efficient configuration of appropriate control parameters. Moreover, it becomes possible to efficiently perform the exploration and adjustment of control parameters. Additionally, the user can easily grasp the progress during the exploration or adjustment through the displayed information, trial history, etc. As a result, even inexperienced users such as newcomers can efficiently configure appropriate control parameters.

### <Data Structure>

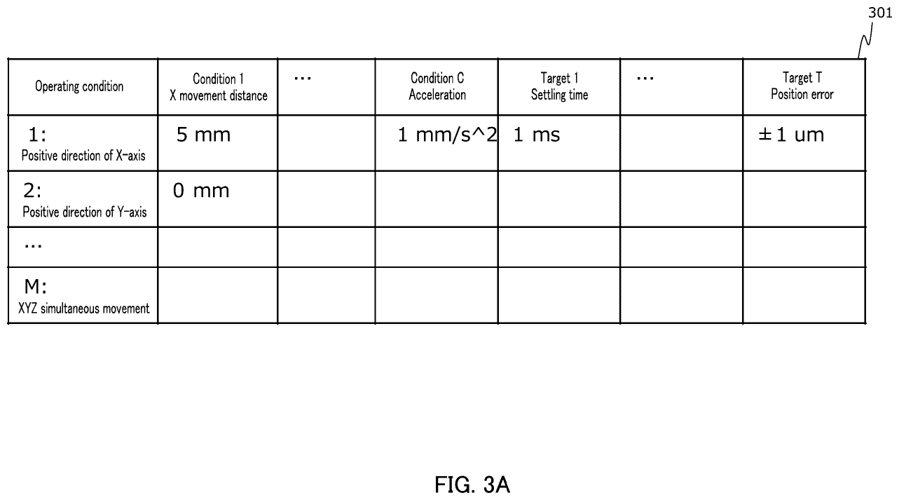

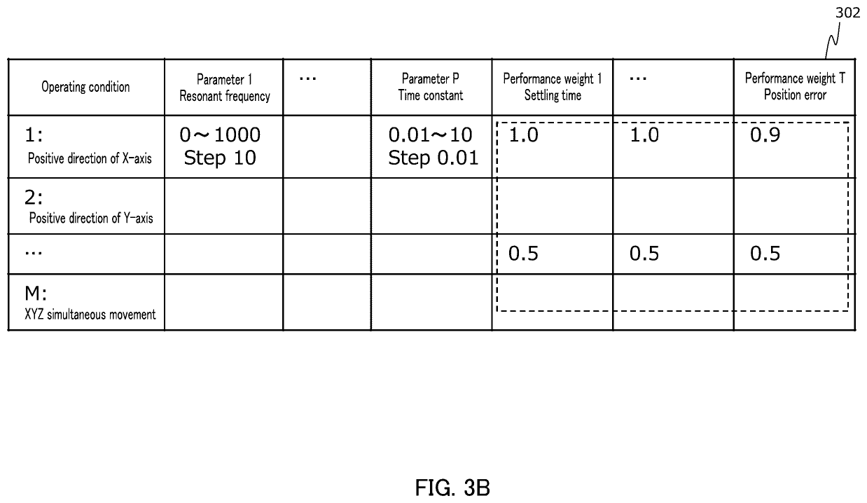

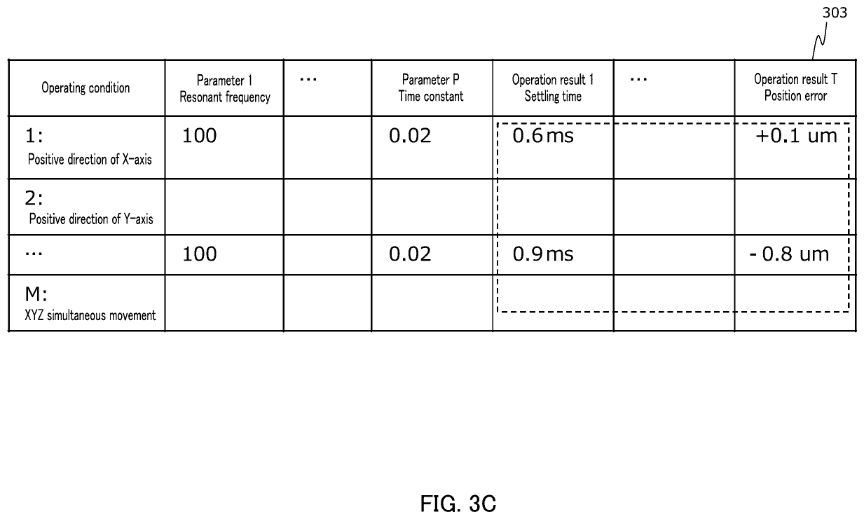

FIGS. 3A to 3C are diagrams showing examples of the data structure of adjustment items according to the embodiment of the present disclosure. It should be noted that the adjustment items shown are merely examples, and appropriate adjustment items may be configured according to equipment 104 for configuration.

In FIG. 3A, exemplary operation parameters 301 are shown; in FIG. 3B, exemplary control parameters 302 are shown; and in FIG. 3C, exemplary evaluation parameters 303 are shown.

As shown in FIGS. 3A to 3C, the adjustment items are composed of M operating conditions, and operation parameters are configured for each operating condition. The operating conditions here refer to operation patterns decomposed into partial operations, such as an operation of an arm, a mounting operation of parts, etc.

Operation parameters 301 define the desired operation of equipment 104 and, in the example shown in FIG. 3A, are composed of C condition parameters and T target performance parameters. The condition parameters may include, for example, movement direction, movement distance, acceleration, acceleration time, acceleration limit value, etc. The target performance parameters may include, for example, settling time for positioning, position error, overshoot amount of vibration, etc.

Control parameters 302 define the configuration range of the control parameters of equipment 104 and, in the example shown in FIG. 3B, are composed of P control parameters and T performance weight parameters. The control parameters may include, for example, numerical data such as the resonant frequency of a control filter, time constant, control gain, etc., the configurable range that can be configured for equipment 104 such as category data such as filter configuration mode settings, etc., configuration units (steps), discrete value sets, etc. The performance weight parameters may be used to configure how much weight to assign to each item of the target performance in the evaluation.

The control parameters selected from these input data are configured for equipment 104 (including the model). Accordingly, equipment 104 performs the predetermined operation according to the configured control parameters. Then, sensor 105 detects (senses, measures) the performance value, which is the operation result of the operation.

Evaluation parameters 303 are evaluation values used during parameter exploration, and are weighted values using performance weight parameters for respective output results (performance values; for example, operation results 1 to T shown in FIG. 3C) of sensor 105, which indicate the operation results of equipment 104 when the control parameters (trial vectors; for example, parameters 1 to P shown in FIG. 3C) are configured for M operating conditions. For example, when the target performance is met under all the operating conditions, the weights for all the parameters are configured equally. On the other hand, when the operating conditions are prioritized (are given priorities) or a desired performance is prioritized (given a priority) for each operating condition, the evaluation values may be calculated by adjusting the weights. Additionally, the evaluation values may be values obtained by converting the weighted output results using an evaluation function. The evaluation function may simply sum the weighted output results, or it may sum the converted values of achievement (ratio) of the output results with respect to target performances.

Next, the objective values will be explained.

The objective values may be, for example, values representing predetermined performances including a position accuracy, settling time, vibration, noise, power consumption, etc., their combinations (e.g., total), weighted values of these, or combinations (e.g., total) of these weighted values, or various statistical feature values such as the mode, minimum, maximum, average, etc., of the evaluation values for all operating conditions (e.g., operating conditions 1 to M shown in FIGS. 3A to 3C). When weighting is used, performance weight parameters (not shown) are configured respectively for performance (e.g., settling time, position error shown in FIG. 3C), similar to the aforementioned performance weight parameters.

### <Display Screen>

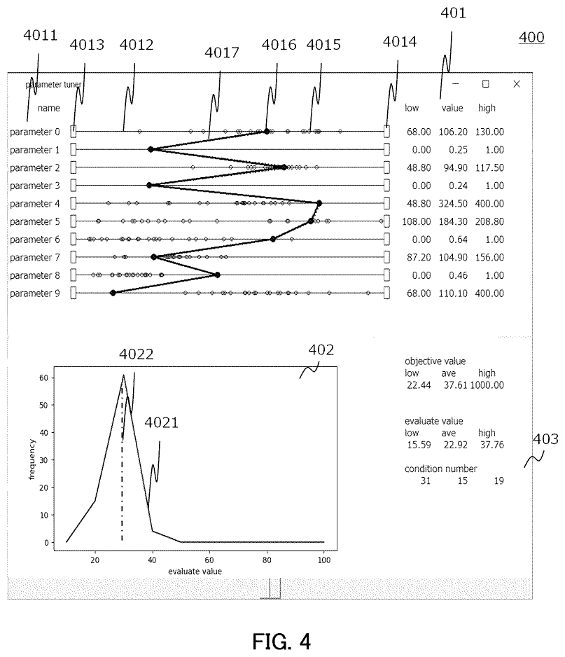

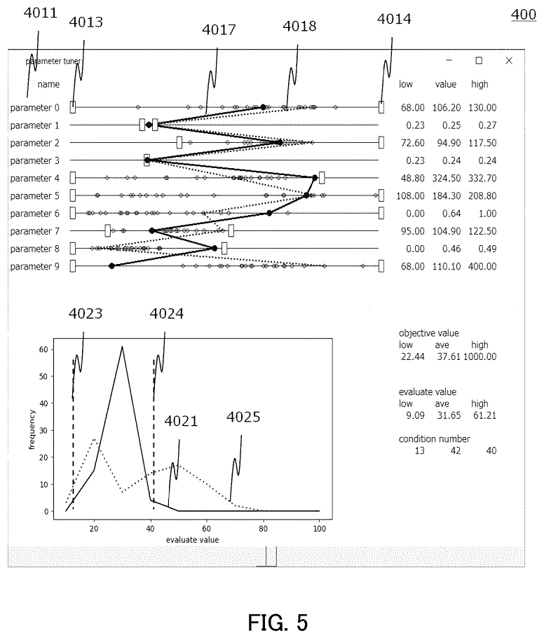

Next, an example of a display screen (also called a UI screen) displayed on UI section 101 will be described with reference to FIGS. 4 and 5. The display screen may be displayed via a dedicated application for configuring parameters in communication with parameter automatic adjustment apparatus 103, or it may be displayed via a web browser.

FIG. 4 is a diagram showing an example of a display screen (also called a UI screen) displayed on UI section 101 according to an embodiment of the present disclosure.

Display screen 400 includes, for example, parameter configuration display area 401, objective value/evaluation value graph display area 402, objective value/evaluation value numerical configuration display area 403, parameter order rearrangement handle 4011, parameter value display axis 4012, exploration lower limit handle 4013, exploration upper limit handle 4014, trial value distribution marker 4015, configuration value handle 4016, configuration value vector line 4017, evaluation value distribution line 4021, and objective value line 4022.

In display screen 400, the user can display or manipulate the range of each parameter, the distribution of trial values, and the like by manipulating UI section 101.

In display screen 400, combinations of parameter values (vectors) are displayed as a polygonal line, and the user can manipulate each vertex via UI section 101. Additionally, in display screen 400, the evaluation value distribution for all operating conditions by each vector is displayed as a histogram, and statistical information such as the best value, worst value, and the operating condition at that time for evaluation and objective values are displayed.

Parameter configuration display area 401 is an area for configuring or displaying parameters to be explored (e.g., parameter 0 to parameter 9 in the figure), and it displays parameter values on a number line and in text. Parameter configuration display area 401 uses the number line to display a numerical axis normalized by the configurable minimum and maximum values, and displays the minimum value (e.g., the “low” field in the figure), maximum value (e.g., the “high” field in the figure), and actual (trial) value (value before normalization) (e.g., the “value” field in the figure) in text in a text area. For example, regarding parameter 0, the configurable range is [68, 130], and 106.20 is configured as the trial value. The same applies to the other parameters. In this example, the vector is represented as a polygonal line [106.20, 0.25, 94.90, . . . , 104.90, 0.46, 110.10].

Objective value/evaluation value graph display area 402 displays distribution graphs of objective and evaluation values during exploration trials.

Objective value/evaluation value numerical configuration display area 403 displays the numerical values of specific points on the graph displayed in objective value/evaluation value graph display area 402 in text in a text area. Objective value/evaluation value numerical configuration display area 403 displays, for example, the minimum value (the “low” field in the figure), average value (the “ave” field in the figure), maximum value (the “high” field in the figure), and the like of the objective value (“objective value” in the figure) distribution during exploration trials. Additionally, objective value/evaluation value numerical configuration display area 403 displays the minimum value (the “low” field in the figure), average value (the “ave” field in the figure), maximum value (the “high” field in the figure), and the like of the evaluation value (evaluate value in the figure) distribution, and simultaneously displays the operating condition number (“condition number” in the figure) where these values were obtained. In this example, the objective and evaluation values represent settling time.

Parameter order rearrangement handle 4011 is a handle for indicating the name of the parameter to be manipulated and manipulating that row, and by moving it in the row direction (up and down), the order of parameters to be displayed can be rearranged. By linking this movement manipulation with the priority (priority order) of the exploration parameters, which are hyperparameters, the user can perform manipulations such as configuring the exploration priority (priority order) to decrease from the parameter displayed at the top.

Parameter value display axis 4012 displays the parameter value of the parameter to be manipulated on a number line. Parameter value display axis 4012 displays a numerical axis normalized by the configurable minimum and maximum values for each parameter. When the parameter value takes discrete values, parameter value display axis 4012 may display its configuration step (interval).

Exploration lower limit handle 4013 is a handle for configuring the exploration lower limit of the parameter to be manipulated, and it configures the hyperparameter to raise the exploration lower limit by being moved to the right and lower the hyperparameter by being moved to the left. In conjunction with this movement manipulation, the parameter value of the exploration lower limit is displayed in the lower limit value field of the text area (e.g., the “low” field in the figure). Additionally, the lower limit value field of the text area may be inputtable, and in that case, the position of exploration lower limit handle 4013 may be changed in conjunction with the value entered in that field.

Exploration upper limit handle 4014 is a handle for configuring the exploration upper limit of the parameter to be manipulated, and it configures the hyperparameter to lower the exploration upper limit by being moved to the left and raise the hyperparameter by being moved to the right. In conjunction with this movement manipulation, the parameter value of the exploration upper limit is displayed in the upper limit value field of the text area (e.g., the “high” field in the figure). Additionally, the upper limit value field of the text area may be inputtable, and in that case, the position of exploration upper limit handle 4014 may be changed in conjunction with the value entered in that field.

When exploration lower limit handle 4013 and exploration upper limit handle 4014 are configured to the same position, that parameter may be fixed to the value corresponding to that position, and exploration of that parameter may not be conducted.

Scatter plot generator 1065, vector diagram generator 1066, or another functional section (processor) (not shown) included in adjustment item setter 106 generates another lower limit value (exploration lower limit handle 4013) and upper limit value (exploration upper limit handle 4014) that, to limit the parameter values configured respectively for a plurality of parameters to configuration within a narrower range, define a narrower range than the configurable range defined by the predetermined configurable minimum (lower limit) and maximum (upper limit) values in parameter configuration display area 401, in such a manner that the user can change the range, and output the generated range to UI section 101 for display.

Trial value distribution marker 4015 is a marker indicating the distribution of values configured for that parameter during exploration trials or in the past. Depending on the configured number of times, one or more of the concentration, color, shape, and the like of trial value distribution marker 4015 may be changed and displayed. This allows displaying the history, such as where frequently configured values and rarely configured values are located. Additionally, based on the evaluation value of the configured values, one or more of the size, pattern, and the like of trial value distribution marker 4015 may be changed and displayed. This makes it easier to understand the relationship between trial values and evaluation values. Scatter plot generator 1065 generates a scatter plot of trial values (parameter values) with different display modes for these parameter values according to the number of times the parameter value of each control parameter is configured.

Configuration value handle 4016 is a handle for expressing the parameter value to be configured or currently configured, and it can decrease the parameter value by being moved to the left and increase it by being moved to the right. In conjunction with this movement manipulation, the parameter value is displayed in the configuration value field of the text area (e.g., the “value” field in the figure). Additionally, the configuration value field of the text area may be inputtable, and in such a case, the position of configuration value handle 4016 may be changed in conjunction with the value entered in the field.

Scatter plot generator 1065, vector diagram generator 1066, or another functional unit (processor) included in adjustment item setter 106 (not shown) generates parameter values (configuration value handle 4016) configured respectively for the plurality of control parameters in a manner that the user can changed the values, and outputs the values to UI section 101 for display.

Configuration value vector line 4017 represents a combination of configuration parameter values (vector) and is displayed as a polygonal line connecting the configuration parameter values (configuration value handle 4016) in order of exploration priority (from top to bottom). By displaying this shape, comparison with another vector under trial or another vector configured in the past becomes visually easy. The polygonal line diagram of the configuration parameter values is generated by vector diagram generator 1066.

Evaluation value distribution line 4021 displays the distribution of evaluation values, which are the results of operational evaluation conducted under a plurality of operating conditions by configuring the currently designated vector to equipment 104, in a histogram. For example, evaluation value distribution line 4021 displays in histogram 100 the evaluation values obtained by configuring each parameter value indicated by configuration value vector line 4017 (e.g., parameter 0 to parameter 10 in the figure) for equipment 104 and operating equipment 104 under 100 different operating conditions. For example, in the example shown in FIG. 4, it can be read that there are 60 operating conditions (frequency in the figure) where the evaluation value (“evaluate value” in the figure) is around 30. The histogram of the evaluation value distribution is generated by distribution diagram generator 1067.

Objective value line 4022 displays the objective value for parameter exploration. For example, when the user configures the mode of the evaluation values for all the operating conditions as the objective value (via UI section 101), objective value line 4022 is displayed at the mode of evaluation value distribution line 4021. Alternatively, various statistical feature values such as the minimum, maximum, or average of the evaluation values for all operating conditions may be used as the objective value.

In this way, by displaying and making manipulatable the range for each parameter, vector, trial values, and distribution of evaluation values on display screen 400, the user can easily grasp the relationship between the combination of numerous parameters (vector) and evaluation values.

FIG. 5 is a diagram illustrating an example of a display screen (UI screen) displayed on UI section 101 according to an embodiment of the present disclosure. Display screen 400 shown in FIG. 5 is a screen after several manipulations have been performed on display screen 400 shown in FIG. 4.

In addition to some elements in display screen 400 shown in FIG. 4, display screen 400 shown in FIG. 5 displays, for example, trial vector line 4018, evaluation value minimum line (also called minimum value line) 4023, evaluation value maximum line (also called maximum value line) 4024, and trial vector evaluation value distribution line 4025.

In display screen 400 shown in FIG. 5, for example, the parameter exploration priorities (priority order) are configured in the order of parameter 0 to parameter 9. For parameter 0, the exploration range is the same as the configurable range. Meanwhile, for parameter 1, the exploration lower limit and exploration upper limit are moved to configure a narrower exploration range, and for parameter 2, the exploration lower limit is moved to a value greater than the lower limit of the configurable range. Additionally, for parameter 3, exploration lower limit handle 4013 and exploration upper limit handle 4014 are moved to the same position and configured to a fixed value.

When such hyperparameters are configured and the exploration begins, trial parameter values (vector) are generated, and trial vector line 4018 representing the trial vector is displayed. Additionally, trial vector evaluation value distribution line 4025, representing the distribution of operational evaluation values by trial vector line 4018, is displayed. Since evaluation value distribution line 4021, representing the distribution of operational evaluation values by configuration value vector line 4017 selected from trial vectors, is also displayed, it is possible to compare the vector and the evaluation value distribution.

Additionally, evaluation value minimum line 4023, representing the minimum evaluation value in the selected evaluation value distribution, and evaluation value maximum line 4024, representing the maximum evaluation value in the selected evaluation value distribution, are displayed.

Additionally, the distribution of trial parameters (trial values) under exploration, the vector, and the evaluation value distribution are displayed, and when selected by user via UI section 101, related information may be highlighted.

### <Operation of Parameter Automatic Adjustment System>

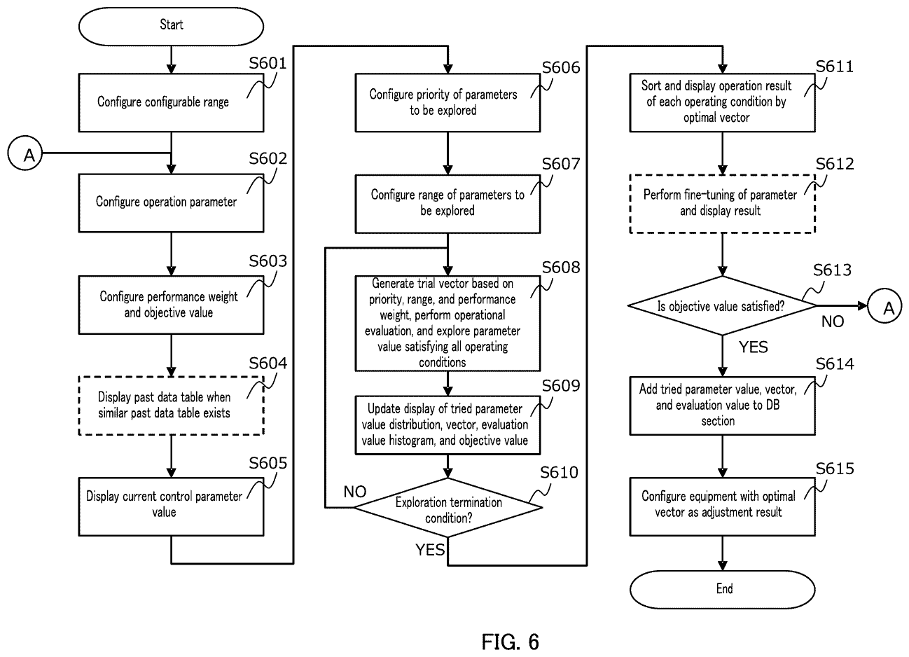

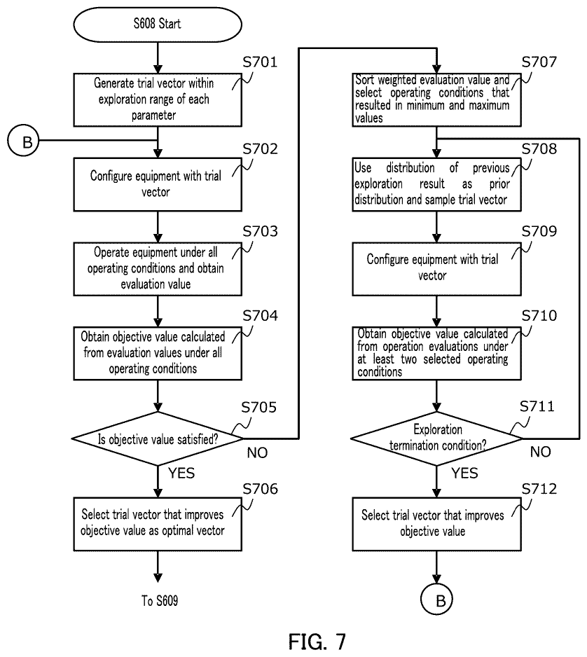

Next, referring to FIGS. 6 and 7, an example of the operation of parameter automatic adjustment system 100 will be described.

FIG. 6 is a flowchart illustrating an example of the operation of parameter automatic adjustment system 100 according to an embodiment of the present disclosure.

In step S601, parameter automatic adjustment apparatus 103 reads the definition of control parameters for adjustment target equipment 104 from DB section 102 (operating condition/control condition DB 1021) and configures the configurable range in a data table (e.g., see FIG. 3B).

In step S602, parameter automatic adjustment apparatus 103 configures the operation parameters for operating adjustment target equipment 104, input from UI section 101, in a data table (e.g., see FIG. 3A).

In step S603, parameter automatic adjustment apparatus 103 configures the performance weight and objective value of the evaluation value based on the input from UI section 101 and information stored in DB section 102.

In step S604, under the control of parameter automatic adjustment apparatus 103, UI section 101 displays a past data table when it exists in DB section 102 and is similar to the current data table configured in the previous steps. Through step S604, when there are parameters and adjustment results from past adjustments made to the same model or similar models under conditions similar to those configured in the previous steps, those adjustment results can be displayed as an example of the configuration values.

In step S605, under the control of parameter automatic adjustment apparatus 103, UI section 101 displays currently configured control parameter values using configuration value handle 4016. For example, before the start of the exploration, default initial values configured in DB section 102 or values that satisfied the objective value in the past can be used as control parameter values.

In step S606, according to the manipulation of parameter order rearrangement handle 4011 by the user, parameter automatic adjustment apparatus 103 configures the priority of the parameters to be explored. Regarding priority, for example, before the start of the exploration, default priorities configured in DB section 102 or priorities that satisfied the objective value in the past can be used.

In step S607, according to the manipulation of exploration lower limit handle 4013 and/or exploration upper limit handle 4014 by the user, parameter automatic adjustment apparatus 103 configures the range of parameters to be explored. Regarding the exploration range, for example, before the start of the exploration, default exploration ranges configured in DB section 102 or exploration ranges that satisfied the objective value in the past can be used.

In step S608, parameter automatic adjustment apparatus 103 generates trial vectors based on the configured priority, range, and performance weight, performs operational evaluation, and explores parameter values that satisfy all the operating conditions.

In step S609, under the control of parameter automatic adjustment apparatus 103, UI section 101 updates the display of the distribution of trial values (parameter values), vectors, evaluation value histograms, objective values, etc.

In step S610, parameter automatic adjustment apparatus 103 determines whether an exploration termination condition has been reached. The exploration termination condition may be configured in advance (e.g., by the user via UI section 101) as one or more of the following: discovery of a parameter satisfying a predetermined objective value, reaching a predetermined number of times of exploration, and reaching a predetermined exploration time.

When the exploration termination condition has not been satisfied (step S610; NO), the flow returns to step S608.

On the other hand, when the exploration termination condition has been satisfied (step S610; YES), the flow proceeds to step S611.

In step S611, under the control of parameter automatic adjustment apparatus 103, UI section 101 sorts and displays the operation result of each operating condition based on the vector (optimal vector) with which the exploration is conducted and which results in the best result.

In step S612, parameter automatic adjustment apparatus 103 performs fine-tuning of the parameters as necessary, according to the manipulation of configuration value handle 4016 by the user. Then, under the control of parameter automatic adjustment apparatus 103, UI section 101 displays the operational evaluation results by the fine-tuned vector.

In step S613, parameter automatic adjustment apparatus 103 determines whether the final operational evaluation results satisfy the objective value.

When the objective value is not satisfied (step S613; NO), the flow returns to step S602.

On the other hand, when the objective value is satisfied (step S613; YES), the flow proceeds to step S614.

In step S614, parameter automatic adjustment apparatus 103 adds the information used for the exploration, hyperparameters, trial values (parameter values), vectors, evaluation values, and the like to DB section 102.

In step S615, parameter automatic adjustment apparatus 103 configures equipment 104 with the optimal vector as the adjustment result. Then, the flow ends.

In this manner, parameter automatic adjustment system 100 allows the information, trial history, and the like configured for parameter automatic adjustment apparatus 103 to be displayed to the user, enabling the user to manipulate the exploration conditions while referring to (e.g., comparing) configured parameters in the past, thereby making it possible to efficiently configure appropriate control parameters. Moreover, it becomes possible to efficiently perform the exploration and adjustment of control parameters. Additionally, the user can easily grasp the progress during the exploration or adjustment through the displayed information, trial history, etc. This allows even inexperienced users, such as newcomers, to efficiently configure appropriate control parameters.

Furthermore, by repeatedly adjusting the hyperparameters related to the exploration, performing automatic explorations based on these adjustments, and making fine adjustments by the user, it becomes possible to efficiently explore and adjust parameters that satisfy the objective value while also referring to past trial histories.

FIG. 7 is a flowchart showing the details of step S608 illustrated in FIG. 6. In the example shown in FIG. 7, among all operating conditions, the operating condition with the minimum evaluation value and the operating condition with the maximum evaluation value are identified, and by repeating similar processing for an operating condition subset including these operating conditions, vector exploration is performed.

In step S701, parameter automatic adjustment apparatus 103 generates trial vectors within the exploration range of each parameter. For example, parameter automatic adjustment apparatus 103 can generate the trial vectors using any appropriate sampling method, such as random sampling, Bayesian sampling, or sampling based on genetic algorithms.

In step S702, parameter automatic adjustment apparatus 103 configures the trial vectors for equipment 104 as an optimization target.

In step S703, parameter automatic adjustment apparatus 103 operates equipment 104 as an optimization target under all the operating conditions and obtains the evaluation value for each operating condition.

In step S704, parameter automatic adjustment apparatus 103 obtains the objective value calculated based on the evaluation values under all operating conditions.

In step S705, parameter automatic adjustment apparatus 103 determines whether the objective value obtained in step S704 satisfies the objective value configured for the exploration (e.g., by user via UI section 101).

When the objective value is satisfied (step S705; YES), the flow proceeds to step S706.

On the other hand, when the objective value is not satisfied (step S705; NO), the flow proceeds to step S707.

In step S706, parameter automatic adjustment apparatus 103 selects the trial vector that improved the objective value as the optimal vector. Then, the flow proceeds to step S609.

In step S707, parameter automatic adjustment apparatus 103 sorts the weighted evaluation values and selects the operating conditions that resulted in the minimum and maximum values, respectively.

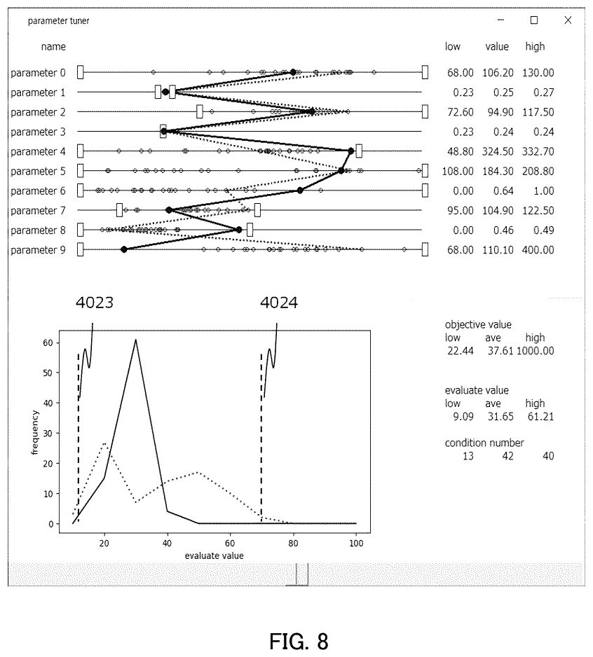

A specific example related to step S707 will be described with reference to FIG. 8. For example, in the example shown in FIG. 8, parameter automatic adjustment apparatus 103 selects the operating condition number that resulted in the minimum evaluation value indicated by minimum value line 4023 of the evaluation value distribution line (dotted line) for the trial vector (dotted line) (e.g., operating condition 13 displayed in the text area (condition number: 13)) and the operating condition number that resulted in the maximum evaluation value indicated by maximum value line 4024 (e.g., operating condition 40 displayed in the text area (condition number: 40)).

In step S708, parameter automatic adjustment apparatus 103 uses the distributions of parameter values from previous exploration results as prior distributions and generates a trial vector by combining parameter values sampled from these distributions, such that the objective value is improved.

In step S709, parameter automatic adjustment apparatus 103 configures equipment 104 as an optimization target with the trial vector generated in step S708.

In step S710, parameter automatic adjustment apparatus 103 performs operation evaluations on at least two operating conditions selected in S707 (e.g., operating conditions 13 and 40 in the example shown in FIG. 8 above) and obtains the objective value calculated based on evaluation values of these operation evaluations.

In step S711, parameter automatic adjustment apparatus 103 determines whether a predetermined exploration termination condition is satisfied (e.g., whether the objective value is improved).

When the predetermined exploration termination condition is satisfied (step S711; YES), the flow proceeds to step S712.

On the other hand, when the predetermined exploration termination condition is not satisfied (step S711; NO), the flow returns to step S708.

In step S712, parameter automatic adjustment apparatus 103 selects the trial vector that improves the objective value. Then, the flow returns to step S702.

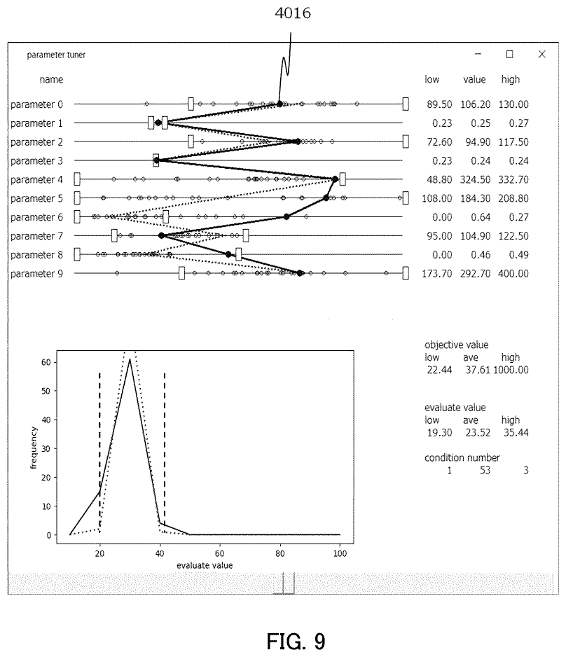

A specific example related to step S712 will be described with reference to FIG. 9. For example, when the objective value is configured to reduce a variation in evaluation values, the minimum value line and the maximum value line approach each other as shown in FIG. 9, and parameter automatic adjustment apparatus 103 selects trial vector (configuration value handle) 4016 with reduced variation in the evaluation value distribution.

Note that in step S705, parameter automatic adjustment apparatus 103 may determine whether the predetermined exploration termination condition is satisfied, and when the predetermined exploration termination condition is satisfied, the flow may proceed to step S706, and when the predetermined exploration termination condition is not satisfied, the flow may proceed to step S707.

By exploring vectors in this way, it is possible to conduct many trials of exploration of a vector which reconcile operating conditions that are not compatible with the same vector (an operating condition with the minimum evaluation value and an operating condition with the maximum evaluation value). Additionally, by displaying the trend of the overall evaluation value each time while reducing the number of evaluations for all the operating conditions, the user can adjust the hyperparameters (see, for example, FIGS. 8 and 9), thereby making efficient the exploration of vectors that satisfy a plurality of operating conditions.

### Variation

Next, a variation of the above-described embodiment will be explained. In this variation, the explanation will mainly focus on configurations and operations different from the above-described embodiment, and the explanation of configurations and operations identical or similar to the above-described embodiment will be omitted.

In this variation, a plurality of parameter automatic adjustment systems identical or similar to above-described parameter automatic adjustment system 100 operate in coordination via a network. For this purpose, a remote control system is provided to control the coordination between these systems.

### <Configuration of Remote Parameter Automatic Adjustment System>

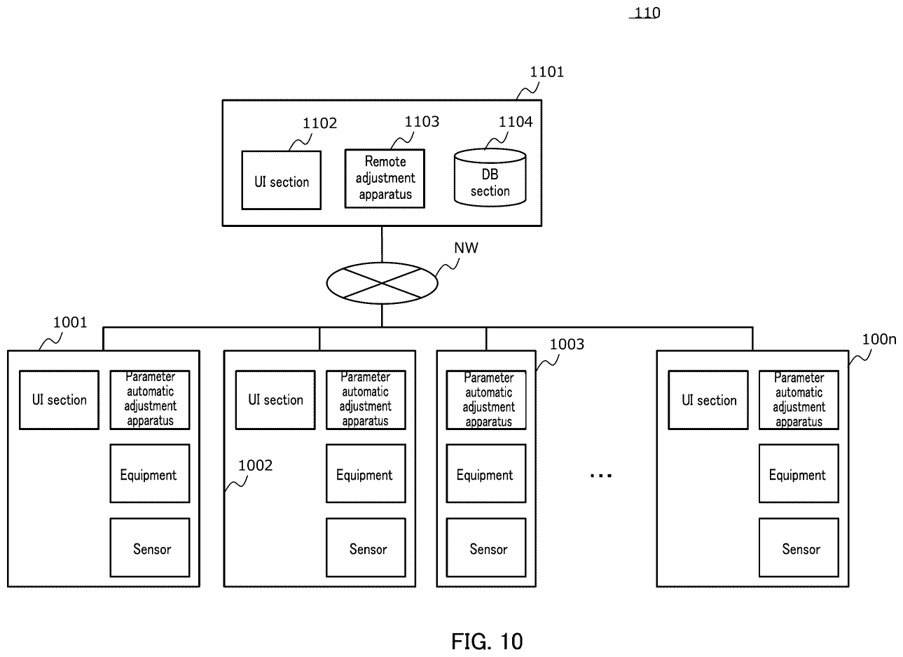

FIG. 10 is a block diagram illustrating an example of a remote parameter automatic adjustment system according to this variation. As shown in FIG. 10, remote parameter automatic adjustment system 110 includes local parameter automatic adjustment systems 1001 to 100n and remote control system 1101. Remote parameter automatic adjustment system 110 and local parameter automatic adjustment systems 1001 to 100n are connected to one another via a network.

As shown in FIG. 10, for example, local parameter automatic adjustment systems 1001, 1002, and 100n are identical or similar to parameter automatic adjustment system 100 except that they do not include a DB section, whereas local parameter automatic adjustment system 1003 does not have UI section 101 of parameter automatic adjustment system 100. Note that local parameter automatic adjustment system 1003, which does not have a UI section, can connect to local parameter automatic adjustment systems 1001, 1002, 100n, and the like, and thus connect to UI section 1102 of these systems, allowing local parameter automatic adjustment system 1003 to also have UI functionality. Additionally, some or all of local parameter automatic adjustment systems 1001 to 100n may include a DB section.

As shown in FIG. 10, for example, remote control system 1101 includes UI section 1102, remote adjustment apparatus 1103, and DB section 1104.

Remote control system 1101 remotely controls each of the plurality of local parameter automatic adjustment systems 1001 to 100n via network NW.

UI section 1102 has the same or similar functions as the UI sections of local parameter automatic adjustment systems 1001 to 100n (e.g., UI section 101 of parameter automatic adjustment system 100).

Remote adjustment apparatus 1103 has the same or similar functions as the parameter automatic adjustment apparatuses of local parameter automatic adjustment systems 1001 to 100n (e.g., parameter automatic adjustment apparatus 103 of parameter automatic adjustment system 100).

Remote adjustment apparatus 1103, in addition to its function, includes a remote controller (not shown) capable of performing control such as causing a plurality of parameter automatic adjustment apparatuses of local parameter automatic adjustment systems 1001 to 100n to execute a plurality of operational evaluations in parallel, and causing the plurality of parameter automatic adjustment apparatuses to indicate to one another the parameter distributions explored by the plurality of parameter automatic adjustment apparatuses. This makes it possible to improve the efficiency of exploration among a plurality of local parameter automatic adjustment systems 1001 to 100n.

DB section 1104 has the same or similar functions as the DB sections of local parameter automatic adjustment systems 1001 to 100n (for example, DB section 102 of parameter automatic adjustment system 100).

DB section 1104 can further centralize and manage exploration histories, hyperparameters, and the like in local parameter automatic adjustment systems 1001 to 100n. This enables efficient parameter exploration for the same model under different operating conditions and environments, and also allows for efficient parameter exploration under similar operating conditions and environments for different models.

In addition to the effects in the above embodiment, remote control system 1101 can perform parameter automatic exploration and adjustment remotely while referring to parameters of other equipment of the same model or parameters under the same operating conditions for different models.

In the above embodiment (including the variation), an example is described where the trial value (parameter value) scatter plot and vector diagram (line graph) generated respectively by scatter plot generator 1065 and vector diagram generator 1066 are displayed on the display screen, but at least one of the trial value scatter plot and vector diagram may be displayed on the display screen. Additionally, the evaluation value distribution diagram (histogram) generated by distribution diagram generator 1067 may also be displayed on the display screen, or it may not be displayed. For example, the user may instruct parameter automatic adjustment apparatus 103 via UI section 101 as to which of the trial value scatter plot, vector diagram, and evaluation value distribution diagram is generated and displayed.

One or more of the functional sections (processors) described in the above embodiment (including the variation) (see FIGS. 2B and 2C, etc.) may be integrated as needed, or one functional section (processor) may be divided into a plurality of sub-functional sections (sub-processors).

The orders of steps in the flowcharts described in the above embodiment are merely an example and are not limited to the orders shown.

The descriptions in the above embodiment may be combined as appropriate unless they are contradictory or explicitly stated to be uncombinable.

In the above-described embodiment, the expression “section” may be replaced with another expression such as “circuit (circuitry),” “assembly,” “device,” “unit,” or “module.”

### <Effect of Embodiment>

Adjustment item setter 106 (scatter plot generator 1065, vector diagram generator 1066) of parameter automatic adjustment apparatus 103 acquires past parameter values of a plurality of control parameters configured for equipment 104 in the past. Adjustment item setter 106 generates first information (parameter value scatter plot) indicating a parameter value scatter state for each control parameter based on the acquired past parameter values. Alternatively or additionally, adjustment item setter 106 may generate second information (line graph) indicating the state of each configuration expressed using one or more line segments based on the acquired past parameter values. Adjustment item setter 106 displays a current parameter value configured for each of the plurality of control parameters on UI section 101 such that the current parameter value is superimposed on at least one of the generated first information and second information. As a result, UI section 101 displays the current parameter values superimposed on at least one of the first information and second information.

This configuration allows for efficient configuration of control parameters with reference to past parameter values configured for the equipment in the past and indicated in at least one of the first information and second information.

### <Summary of Embodiment>

A parameter adjustment apparatus according to one exemplary embodiment of the present disclosure includes: generation circuitry, which, in operation, acquires a past parameter value for each of a plurality of control parameters configured for equipment in a past, and generates at least one of first information and second information based on the past parameter value, the first information indicating a parameter value scatter state for each control parameter, the second information indicating a state for each configuration, where the past parameter value is expressed using one or more line segments; and display control circuitry, which, in operation, displays a current parameter value configured for each of the plurality of control parameters on a user interface such that the current parameter value is superimposed on at least one of the first information and the second information.

In the present parameter adjustment apparatus, the display control circuitry displays the current parameter value on the user interface in a manner expressed by one or more line segments, the current parameter value being superimposed on the second information.

In the present parameter adjustment apparatus, the generation circuitry generates the first information for each control parameter in a display mode of the past parameter value, the display mode being varied according to a number of times the past parameter value is configured.

In the present parameter adjustment apparatus, the display control circuitry displays a configurable range of the current parameter value on the user interface in a manner changeable by a user.

In the present parameter adjustment apparatus, the display control circuitry displays the current parameter value on the user interface in a manner changeable by a user.

The present parameter adjustment apparatus further includes: evaluation circuitry, which, in operation, evaluates an operation result of the equipment operated according to the current parameter value under a plurality of operating conditions, and generates an evaluation score for the current parameter value, the evaluation score being based on the operation result for each operating condition, in which the generation circuitry further generates a histogram representing a distribution of the evaluation score, and the display control circuitry further displays the histogram on the user interface.

In the present parameter adjustment apparatus further includes: evaluation circuitry, which, in operation, evaluates an operation result of the equipment operated according to the current parameter value under a plurality of operating conditions, and generates an evaluation score for the current parameter value, the evaluation score being based on the operation result for each operating condition; and parameter value generation circuitry, which, in operation, selects a first operating condition in which the evaluation score is minimum and a second operating condition in which the evaluation score is maximum among the plurality of operating conditions, and generates the current parameter value with which a second objective value is obtained, the second objective value being obtained by improving a first objective value representing a predetermined performance calculated at least based on a first evaluation score under the first operating condition and a second evaluation score under the second operating condition, in which the evaluation circuitry repeatedly generates the evaluation score for the current parameter value and the parameter value generation circuitry repeatedly generates the current parameter value until the second objective value satisfies a predetermined condition, and when the second objective value satisfies the predetermined condition, the parameter value generation circuitry determines the generated current parameter value as a parameter value to be configured for the equipment.

A parameter adjustment method according to one exemplary embodiment of the present disclosure includes steps performed by a parameter adjustment apparatus of: acquiring a past parameter value for each of a plurality of control parameters configured for equipment in a past; generating at least one of first information and second information based on the past parameter value, the first information indicating a parameter value scatter state for each control parameter, the second information indicating a state for each configuration, where the past parameter value is expressed using one or more line segments; and displaying a current parameter value configured for each of the plurality of control parameters on a user interface such that the current parameter value is superimposed on at least one of the first information and the second information.

A program according to one exemplary embodiment of the present disclosure causes a computer to execute: acquiring a past parameter value for each of a plurality of control parameters configured for equipment in a past; generating at least one of first information and second information based on the past parameter value, the first information indicating a parameter value scatter state for each control parameter, the second information indicating a state for each configuration, where the past parameter value is expressed using one or more line segments; and displaying a current parameter value configured for each of the plurality of control parameters on a user interface such that the current parameter value is superimposed on at least one of the first information and the second information.

According to the above parameter adjustment apparatus, parameter adjustment method, and program, it becomes possible to efficiently configure control parameters with reference to past parameter values indicated in at least one of the first information and second information and configured for the equipment in the past.

Although the embodiments have been described above with reference to the drawings, the present disclosure is not limited to these examples. Obviously, a person skilled in the art would arrive at variations and modifications within a scope described in claims. It is understood that these variations and modifications are within the technical scope of the present disclosure. Moreover, any combination of features of the above-mentioned embodiments may be made without departing from the spirit of the disclosure.

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

When future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system which is difficult to carry or is stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

Various embodiments have been described with reference to the drawings hereinabove. Obviously, the present disclosure is not limited to these examples. Obviously, a person skilled in the art would arrive variations and modification examples within a scope described in claims, and it is understood that these variations and modifications are within the technical scope of the present disclosure. Moreover, any combination of features of the above-mentioned embodiments may be made without departing from the spirit of the present disclosure.

While examples of the present disclosure have been described in detail above, those examples are mere examples and do not limit the scope of the appended claims. The techniques disclosed in the scope of the appended claims include various modifications and variations of the concrete examples exemplified above.

The disclosure of Japanese Patent Application No. 2023-005785, filed on Jan. 18, 2023, including the specification, drawings and abstract, is incorporated herein by reference in its entirety.

### INDUSTRIAL APPLICABILITY

An exemplary embodiment of the present disclosure is useful for parameter adjustment systems.

### REFERENCE SIGNS LIST

100 Parameter automatic adjustment system
101 User interface (UI) section
102 Database (DB) section
1021 Operating condition/control condition DB
1022 Trial value distribution history DB
1023 Vector distribution history DB
1024 Evaluation value distribution history DB
103 Parameter automatic adjustment apparatus
1031 Trial value distribution acquirer
1032 Vector distribution acquirer
1033 Evaluation value distribution acquirer
104 Equipment
105 Sensor
106 Adjustment item setter
1061 Configurable range input
1062 Exploration priority input
1063 Exploration range input
1064 Vector adjustment input
1065 Scatter plot generator
1066 Vector diagram generator
1067 Distribution diagram generator
107 Parameter explorer
108 Trial vector setter
109 Operation evaluator
110 Remote parameter automatic adjustment system
1001 Local parameter automatic adjustment system
1002 Local parameter automatic adjustment system
1003 Local parameter automatic adjustment system
100n Local parameter automatic adjustment system
1101 Remote control system
1102 UI section
1103 Remote adjustment apparatus
1104 DB section

1. A parameter adjustment apparatus, comprising:
generation circuitry, which, in operation, acquires a past parameter value for each of a plurality of control parameters configured for equipment in a past, and generates at least one of first information and second information based on the past parameter value, the first information indicating a parameter value scatter state for each control parameter, the second information indicating a state for each configuration, where the past parameter value is expressed using one or more line segments; and
display control circuitry, which, in operation, displays a current parameter value configured for each of the plurality of control parameters on a user interface such that the current parameter value is superimposed on at least one of the first information and the second information.

2. The parameter adjustment apparatus according to claim 1, wherein
the display control circuitry displays the current parameter value on the user interface in a manner expressed by one or more line segments, the current parameter value being superimposed on the second information.

3. The parameter adjustment apparatus according to claim 1, wherein
the generation circuitry generates the first information for each control parameter in a display mode of the past parameter value, the display mode being varied according to a number of times the past parameter value is configured.

4. The parameter adjustment apparatus according to claim 1, wherein
the display control circuitry displays a configurable range of the current parameter value on the user interface in a manner changeable by a user.

5. The parameter adjustment apparatus according to claim 1, wherein
the display control circuitry displays the current parameter value on the user interface in a manner changeable by a user.

6. The parameter adjustment apparatus according to claim 1, further comprising:
evaluation circuitry, which, in operation, evaluates an operation result of the equipment operated according to the current parameter value under a plurality of operating conditions, and generates an evaluation score for the current parameter value, the evaluation score being based on the operation result for each operating condition, wherein
the generation circuitry further generates a histogram representing a distribution of the evaluation score, and
the display control circuitry further displays the histogram on the user interface.

7. The parameter adjustment apparatus according to claim 1, further comprising:
evaluation circuitry, which, in operation, evaluates an operation result of the equipment operated according to the current parameter value under a plurality of operating conditions, and generates an evaluation score for the current parameter value, the evaluation score being based on the operation result for each operating condition; and
parameter value generation circuitry, which, in operation, selects a first operating condition in which the evaluation score is minimum and a second operating condition in which the evaluation score is maximum among the plurality of operating conditions, and generates the current parameter value with which a second objective value is obtained, the second objective value being obtained by improving a first objective value representing a predetermined performance calculated at least based on a first evaluation score under the first operating condition and a second evaluation score under the second operating condition, wherein
the evaluation circuitry repeatedly generates the evaluation score for the current parameter value and the parameter value generation circuitry repeatedly generates the current parameter value until the second objective value satisfies a predetermined condition, and
when the second objective value satisfies the predetermined condition, the parameter value generation circuitry determines the generated current parameter value as a parameter value to be configured for the equipment.

8. A parameter adjustment method performed by a parameter adjustment apparatus, comprising:
acquiring a past parameter value for each of a plurality of control parameters configured for equipment in a past;
generating at least one of first information and second information based on the past parameter value, the first information indicating a parameter value scatter state for each control parameter, the second information indicating a state for each configuration, where the past parameter value is expressed using one or more line segments; and
displaying a current parameter value configured for each of the plurality of control parameters on a user interface such that the current parameter value is superimposed on at least one of the first information and the second information.

9. A program for causing a computer to execute:
acquiring a past parameter value for each of a plurality of control parameters configured for equipment in a past;
generating at least one of first information and second information based on the past parameter value, the first information indicating a parameter value scatter state for each control parameter, the second information indicating a state for each configuration, where the past parameter value is expressed using one or more line segments; and
displaying a current parameter value configured for each of the plurality of control parameters on a user interface such that the current parameter value is superimposed on at least one of the first information and the second information.
